(19) United States
(12) Patent Application Publication
(10) Pub. No.: US 2012/0224402 A1
(43) Pub. Date: Sep. 6, 2012

(54) POWER SEMICONDUCTOR MODULE AND POWER SEMICONDUCTOR CIRCUIT CONFIGURATION

(76) Inventor: Andreas Schoenknecht, Renningen (DE)

(21) Appl. No.: 13/395,313

(22) PCT Filed: Aug. 3, 2010
(86) PCT No.: PCT/EP2010/061291

§ 371 Date: May 24, 2012

(30) Foreign Application Priority Data
Sep. 16, 2009 (DE) 10 2009 029 515.1

(51) Int. Cl. H02M 7/537

(52) U.S. Cl. 363/131

(57) ABSTRACT

A power semiconductor module having a substrate, at least two power semiconductor switches being situated on the substrate and connected in parallel, at least one intermediate circuit terminal for connecting the power semiconductor switches to a first supply voltage potential and at least two intermediate circuit terminals for connecting the power semiconductor switches to a second supply voltage potential, one of the supply voltage potentials being negative and the other being positive.

### FIELD OF THE INVENTION

The present invention relates to a power semiconductor module and a power semiconductor circuit configuration.

### BACKGROUND INFORMATION

Polyphase machines, which are operated in combination with inverters—frequently also referred to as power inverters—are used for the drive in hybrid or electric vehicles. An inverter includes at least one power semiconductor module having semiconductor components in the form of power semiconductor switches—hereinafter referred to simply as power switches—for example, MOSFETs (metal oxide semiconductor field-effect transistors), IGBTs (insulated gate bipolar transistors) or MCTs (MOS-controlled thyristors), usually in combination with free-wheeling diodes. Through suitable internal wiring within the module, different circuit variants, such as individual switches, half bridges, whole bridges or also choppers, may be implemented. The individual power switches are usually designed in the form of semiconductor chips situated on a substrate, usually a DCB ceramic substrate. The diodes required for the corresponding circuit variant may be integrated into the power switch chips or designed as separate diode chips. Partial integration is also possible.

To be able to fulfill the requirements of an inverter, in particular when used in a hybrid vehicle, with regard to intermediate circuit voltage and phase current for the required lifetime, multiple power switches must be connected in parallel. The parallel circuit may be implemented within a power semiconductor module, so that multiple power switches connected in parallel are situated on the substrate. Alternatively, multiple power semiconductor modules may also be connected in parallel, each to one substrate, each with power switches situated thereon.

A parallel circuit of power semiconductor modules has the advantage that multiple decoupled commutation circuits are formed, resulting in a reduction in overvoltage spikes. However, at switching frequencies of more than 1 kHz in particular, synchronous triggering of power semiconductor modules connected in parallel is difficult because the contact resistances of the control lines may vary greatly under some circumstances, in particular with an increase in lifetime, which results in a progressive increase in the time difference during switching of the individual semiconductor chips.

However, particular challenges arise in the development of power semiconductor modules having multiple power switches connected in parallel within a module.

Overvoltage spikes are induced on the power switches due to inductances in the commutation circuit. Since the maximum blocking voltage of the individual power switches is limited, excessive overvoltages result in destruction of the power switches. To permit optimal utilization of the chip area of the power switches and, if necessary, the separate diodes, the inductance in the commutation circuit must be minimized. The inductance is approximately proportional to the area which the corresponding commutation current in the commutation circuit must enclose.

Due to an asymmetrical electrical configuration of the individual power switches on the substrate of the module and the resulting differences in path lengths to the individual power switches, the individual power switches may furthermore be switched on and/or off in a nonsimultaneous or nonsynchronous manner. The result is an uneven distribution of load among the power switches, which may thus result in an overload of individual power switches and ultimately in a shortening of the lifetime of the power semiconductor module.

Finally, an asymmetrical electrical configuration of the diodes may result in the current not being divided evenly among the diodes immediately after cut-off of the power switches, which may cause an overload of individual diodes. In the extreme case, it may even happen that a single diode briefly takes on the total current of all power switches connected in parallel, namely directly after the commutation operation. This problem is further exacerbated by power diodes having a negative temperature coefficient below approximately 75° C., which means that at low temperatures, a diode which is under a greater load anyway due to the switching will carry an increased current, also in steady-state operation, in comparison with the other diodes connected in parallel. Ultimately an asymmetrical electrical configuration of the diodes may also shorten the lifetime of the power semiconductor module.

There are fundamentally two approaches to preventing a destruction of power switch chips due to overvoltage spikes. On the one hand, the blocking voltage of the power switch chips may be increased. On the other hand, the inductance in the commutation circuit may be reduced. Since an increase in the blocking voltage results in greater losses in the power switch chip due to the technology used and thus the required chip area increases for the same inverter specification, usually an attempt is made to reduce the inductance in the commutation circuit.

The extent of the overvoltage spikes is determined by the area spanned by the commutation current and thus predominantly by the inductance in the commutation circuit. FIG. 1 shows a simplified equivalent circuit diagram of a commutation circuit including the parasitic equivalent inductances. These are composed of inductances Lzk1 and Lzk2 in an intermediate circuit capacitor 1, inductances Lverb1 and Lverb2 of feeder lines 2 between intermediate circuit capacitor 1 and power semiconductor module 3 as well as inductances Lmodule1 and Lmodule2 within power semiconductor module 3. The sum of all inductances is approximately proportional to the area spanned by the commutation circuit.

German Patent No. DE 42 40 501 A1 describes a power semiconductor circuit configuration in which the positive and negative electrical terminals are each formed by at least two partial terminals situated close to one another and in parallel to reduce voltage spikes caused by rapid switching operations.

### SUMMARY

In accordance with the present invention, a power semiconductor module is provided having a substrate, preferably a DCB ceramic substrate, and at least two power semiconductor switches connected in parallel and situated on the substrate. The power semiconductors are preferably designed as IGBT, MOSFET or MCT semiconductor chips. Furthermore, at least one intermediate circuit terminal for connecting the power semiconductor switches to a first supply voltage potential and at least two intermediate circuit terminals for connecting the power semiconductor switches to a second supply voltage potential are provided according to the present invention, one of the supply voltage potentials being negative and the other being positive. The power semiconductor module may have any number of additional circuit elements, in particular diodes which may either be integrated into the power switch chips or may also be designed as separate semiconductor chips. Partial integration into the power switch chips is also possible. The power semiconductor module may include, for example, individual switches, half bridges, full bridges or also choppers through individual wiring of the individual circuit elements.

A traditional power semiconductor module having multiple parallel-connected power switches includes one intermediate circuit terminal each, having a first positive supply voltage potential of the intermediate circuit and having a second negative supply voltage potential of the intermediate circuit. By dividing at least one of these terminals into at least two partial terminals, the result is at least two pairs of terminals. Since the current flows over the path of the lowest inductance, this yields at least two decoupled commutation circuits, the current being divided among the individual commutation circuits. In the case of division into N partial terminals, the result accordingly is N decoupled commutation circuits. Thus, only 1/N of the original commutation current flows over the individual inductances of each commutation circuit. The overvoltage occurring at the individual power switches within the power semiconductor module is reduced by a factor of 1/N, assuming equal commutation circuit inductances

$${U}_{p} = {L}_{module} \cdot \frac{d I}{d t} .$$

An improved symmetry of the linkage of the individual power switch chips to the intermediate circuit using at least one intermediate circuit capacitor is achieved by dividing at least one of these terminals into at least two partial terminals. In the ideal case, the voltage offset at the emitter or source terminals of the power switches which is important for symmetrical triggering of the power switches and is caused by rapid current changes during a commutation operation may be eliminated completely by such a configuration. Therefore, in comparison with power semiconductor modules such as those known in the related art, the synchronicity of the triggering and thus of the utilization of the chip area of the individual power switches is easily increased substantially.

In addition, a homogeneous current transfer of parallel connected diodes during the cut-off of the power switches is also ensured due to decoupling of the individual commutation circuits, thereby preventing an overload of individual diodes.

According to one specific embodiment of the present invention, an intermediate circuit terminal having a positive supply voltage potential and an intermediate circuit terminal having a negative supply voltage potential are situated in direct proximity to one another on the substrate. The intermediate circuit terminals are situated as close to one another as possible, to thereby minimize the inductance generated by the terminal pairs. The dielectric strength is the limiting factor, which may also be increased further by using an insulation film between the two terminals.

The present invention also creates a power semiconductor circuit configuration, in which the intermediate circuit terminals of a power semiconductor module according to the present invention are electrically connected to at least one intermediate circuit capacitor via feeder lines. A separate feeder line leading from the intermediate circuit capacitor to the power semiconductor module is provided for each intermediate circuit terminal.

According to one advantageous specific embodiment of the power semiconductor circuit configuration, an intermediate circuit terminal having a positive potential and an intermediate circuit terminal having a negative potential are each situated directly adjacent to one another on the power semiconductor module, and the feeder lines connected to them are carried preferably in parallel up to the intermediate circuit capacitor. The inductance generated by the feeder lines may also be reduced in this way.

Additional features and advantages of specific embodiments of the present invention are derived from the description below with reference to the accompanying figures.

### BRIEF DESCRIPTION OF THE DRAWINGS

FIG. 1 shows a simplified equivalent circuit diagram of a commutation circuit having the parasitic equivalent inductances.

FIG. 2 shows a simplified equivalent circuit diagram of a power semiconductor module according to the present invention.

FIG. 3 shows a simplified schematic diagram of a first specific embodiment of a power semiconductor module according to the present invention having two positive and two negative supply voltage terminals.

FIG. 4 shows a simplified schematic diagram of a second specific embodiment of a power semiconductor module according to the present invention having one positive and two negative supply voltage terminals.

FIG. 5 shows a simplified schematic diagram of a third specific embodiment of a power semiconductor module according to the present invention having four positive and four negative supply voltage terminals.

FIG. 6 shows a simplified schematic diagram of a fourth specific embodiment of a power semiconductor module according to the present invention having two positive and three negative supply voltage terminals.

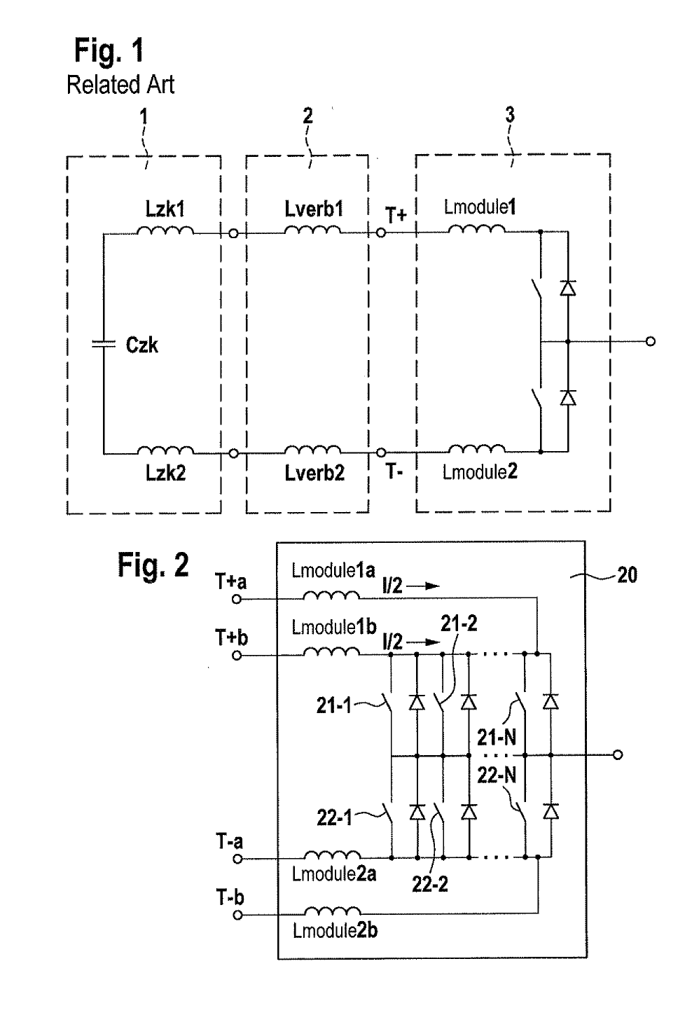

### DETAILED DESCRIPTION OF EXAMPLE EMBODIMENTS

FIG. 2 shows a simplified equivalent circuit diagram of a power semiconductor module 20 according to the present invention for use in an inverter. Power semiconductor module 20 includes a parallel circuit of N circuit paths, each having a series connection of a high-side power switch 21-1 through 21-N and a low-side power switch 22-1 through 22-N, one diode being connected in parallel to each power switch 21 and 22. The terminals of high-side power switches 21 facing away from low-side switches 22 are each connected to a positive supply voltage potential. Two intermediate circuit terminals T+a and T+b are provided, one of the terminals, namely terminal T+b in the example shown here, advantageously being contacted in the area of a first exterior circuit path, namely the left exterior circuit path in this example, whereas the second terminal, namely terminal T+a in the example shown here, is advantageously contacted in the area of the external circuit path situated at a distance from the first circuit path, namely the exterior right circuit path in this example. The terminals of low-side power switches 22 facing away from high-side power switches 21 are each connected to a negative supply voltage potential. Two intermediate circuit terminals T−a and T−b are provided, one of the terminals, namely terminal T−a in the example shown here, again advantageously being contacted in the area of the first exterior circuit path, namely the left exterior circuit path in this example, whereas the second terminal, namely terminal T−b in the example shown here, is advantageously contacted in the area of the exterior circuit path, which is at a distance from the first circuit path, namely the right exterior circuit path in this example.

The terminals between high-side power switches 21 and low-side power switches 22 as well as between the corresponding assigned diodes are interconnected and form a phase terminal 23.

This wiring achieves the result that only half current I/2 flows over module inductances L_{module1a}, L_{module1b}, L_{module2a} and L_{module2b}. In comparison with a conventional power semiconductor module having only one intermediate circuit terminal each for positive and negative supply voltage potentials, the current in the commutation circuit inductances is thus reduced by a factor of 2. Assuming identical values of module inductances L_{module1a}, L_{module1b}, L_{module2a} and L_{module2b} in first approximation, the overvoltage spike is also reduced by a factor of approximately 2 by this measure.

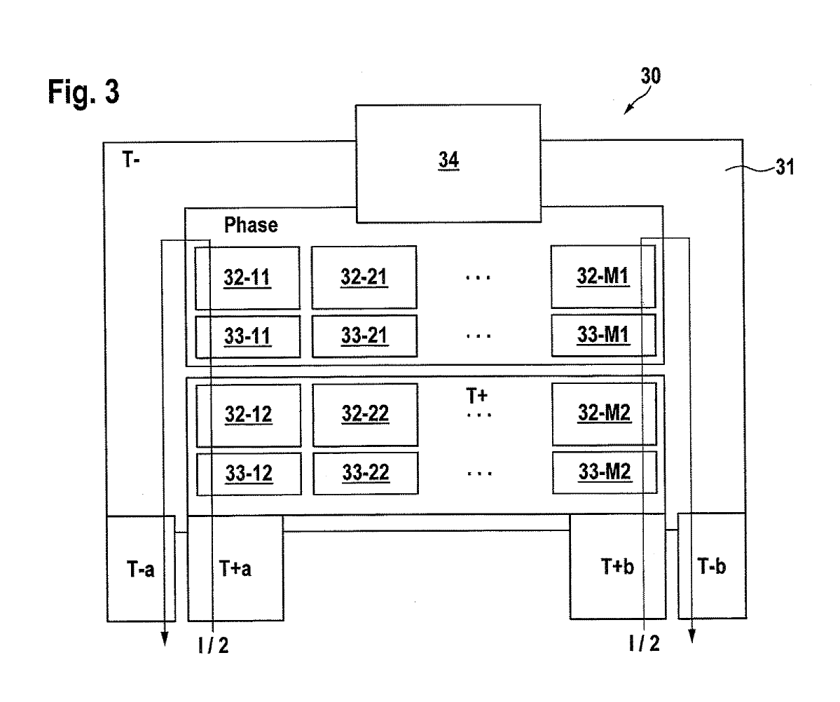

FIGS. 3 through 6 illustrate various specific embodiments of a power semiconductor module according to the present invention. The present invention is described here on the basis of a half-bridge power semiconductor module as an example. However, the internal wiring within the module may also be chosen differently without having any effect on the present invention, so that single-switch modules with or without a separate free-wheeling diode, chopper modules or even whole-bridge modules, for example, may be implemented.

FIG. 3 shows a simplified schematic diagram of a first specific embodiment of a power semiconductor module 30 according to the present invention. Three potential surfaces T+, T− and phase are provided on a substrate 31, preferably a DCB ceramic substrate. According to the half-bridge module selected as an example, M parallel-connected power switch chips 32-11 through 32-M1, and M assigned diode chips 33-11 through 33-M1 are provided in the area of the phase potential surface and M parallel-connected power switch chips 32-12 through 32-M2 as well as M assigned diode chips 33-12 through 33-N2 are provided in the area of potential surface T+ having a positive supply voltage potential. The collector sides of power switch chips 32 are each soldered to the phase potential surface and potential surface T+. The additional connections between the individual chips as well as the other potential surfaces are accomplished via bond wires (not shown). For reasons of simplicity, the control lines for the power switch chips are also not shown.

The terminals of power semiconductor module 30 are implemented via punched grids, for example. A phase terminal 34 is provided here, which is electrically connected to the phase potential surface and may form the output of an inverter, for example. Potential surfaces T− and T+ are each electrically connected to two intermediate circuit terminals T−a and T−b as well as T+a and T+b, via which power semiconductor module 30 is connectable to an intermediate circuit having at least one intermediate circuit capacitor. The intermediate circuit terminals are designed in such a way that they each lie in the area of the exterior circuit paths of the parallel-connected power switches on the one hand and on the other hand an intermediate circuit terminal having a positive supply voltage potential and an intermediate circuit terminal having a negative supply voltage potential are each situated in immediate proximity on substrate 31.

If, as is conventional, a power semiconductor module is equipped with only one intermediate circuit terminal each for positive and negative supply voltage, then the entire commutation current will have the same characteristic over large portions of the module. According to the equation

$${U}_{p} = {L}_{module} \cdot \frac{d I}{d t} ,$$

this results in relatively high overvoltage spikes because of the coupling of the circuits of the individual power switch chips. In addition, during the commutation operation, a relatively great potential shift occurs via the emitter and/or source terminals of the power switches. Each emitter or drain terminal therefore has a different potential during the commutation operation. Since the voltage between the gate and emitter or source is important for the triggering of a power switch, this necessarily results in the power switches being activated and deactivated at different points in time and therefore results in an unequal load on the semiconductor chips. This problem may be prevented by splitting the intermediate circuit terminals into multiple partial terminals and thereby creating decoupled commutation circuits.

FIG. 3 also schematically shows two circuits, highly simplified, these circuits being formed on the two outer circuit paths of the parallel circuit. It is clearly apparent here that two magnetically decoupled circuits are formed. Assuming a uniform module inductance in the commutation circuit, this effect results in overvoltage spikes being reduced by one-half as described above. If one also assumes an electrically symmetrical coupling of intermediate circuit terminals to the intermediate circuit capacitor(s), this also yields an identical shift in the emitter potential of the power switches. Thus, almost exactly simultaneous switching of power switches is achievable. In addition, the current of all parallel-connected power switches is no longer picked up by only one diode in the event of a cut-off in the extreme case but instead is picked up by at least one diode per decoupled commutation circuit, namely two diodes in the present example.

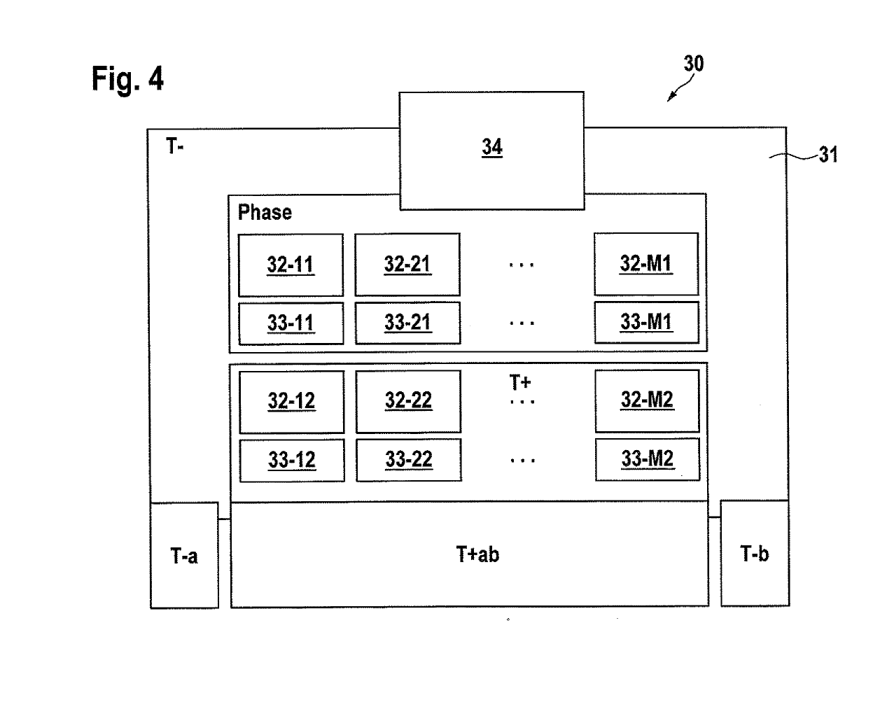

The second specific embodiment of a power semiconductor module according to the present invention illustrated in FIG. 4 differs from the specific embodiment illustrated in FIG. 3 only in that two intermediate circuit terminals T+a and T+b which are situated side by side have been mechanically combined to form a shared intermediate circuit terminal T+ab. However, for the case when neighboring intermediate circuit terminals having the same voltage potential are combined, it is advantageous to make sure that an intermediate circuit terminal having the corresponding inverse supply voltage potential is situated in immediate proximity. With a corresponding design of the module and its intermediate circuit terminals, the mechanical combination of two intermediate circuit terminals having a negative voltage potential situated side by side is, of course, also possible. Combining more than two adjacent intermediate circuit terminals having the same voltage potential is also possible.

If the intermediate circuit terminals for positive and negative supply voltages are each split into N partial terminals, this yields, without combining neighboring intermediate circuit terminals, N decoupled commutation circuits across whose inductances only 1/N times the original commutation current flows. Due to the mechanical combination of intermediate circuit terminals, it is also possible to implement a power semiconductor module which has only K partial terminals, K<N at least for one of the two supply voltage potentials, and nevertheless generating N decoupled commutation circuits.

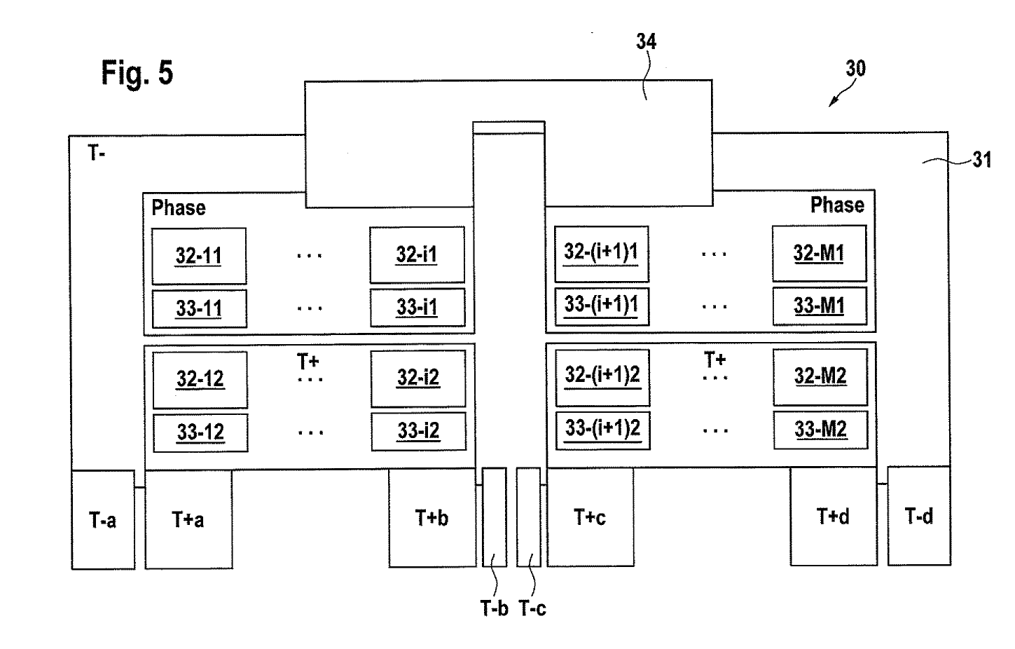

FIG. 5 shows another specific embodiment of a power semiconductor module according to the present invention, wherein in contrast with the specific embodiment illustrated in FIG. 3, not two but instead four partial terminals T+a through T+d and T−a through T−d are provided per supply voltage potential. This constitutes a further improvement with regard to overvoltage spikes, symmetrical switching of the power switches and homogeneous current transfer of the diodes during cut-off of the power switches. In contrast with the specific embodiment according to FIG. 3, two potential surfaces T+ and phase are also provided. However, the design inside the module is irrelevant for the applicability of the present invention, so the selected design generally has reasons based on technical aspects of the figures.

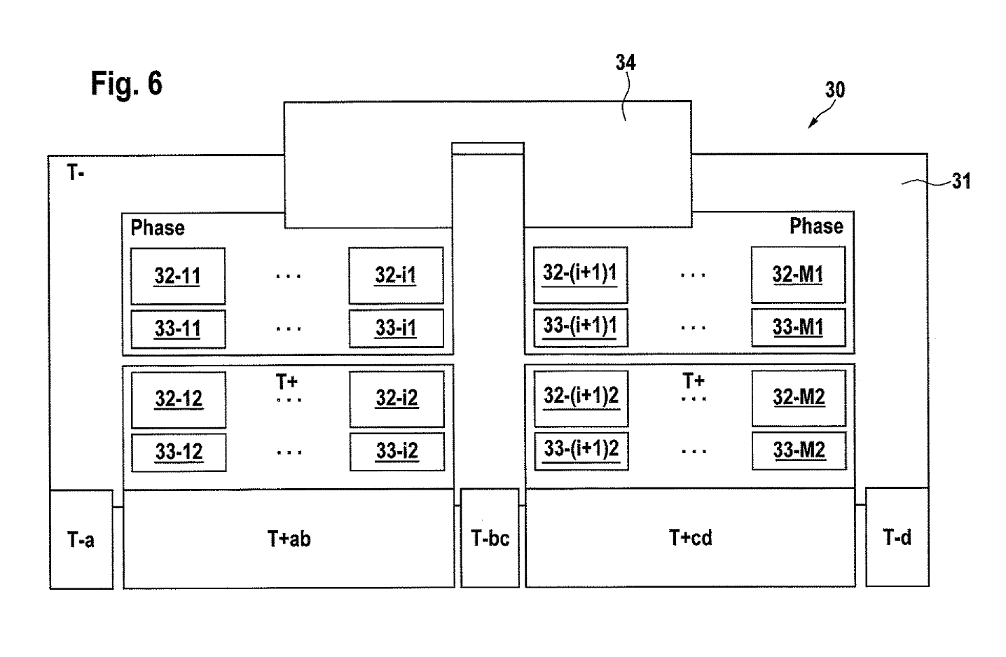

The specific embodiment shown in FIG. 6 differs from the specific embodiment according to FIG. 5 only in that corresponding neighboring intermediate circuit terminals T+a and T+b have been combined mechanically to form one terminal T+ab, T−b and T−c have been combined mechanically to form one terminal T−bc, and T+c and T+d have been combined mechanically to form one terminal T+cd, so that there are ultimately three intermediate circuit terminals for connecting the power switches to a negative supply voltage potential and two intermediate circuit terminals for connecting the power switches to one positive supply voltage potential.

In addition to the specific embodiments depicted here, each having two or four partial terminals, any other number of partial terminals (greater than 1) is also possible.

With the specific embodiments of the present invention shown here, the intermediate circuit terminals are each led out on one side of the power semiconductor module. As an alternative, it is also possible to lead the terminals out on several different sides of the module. This is merely a question of circuit design and generally does not influence the present invention. However, the fact that the connection to the intermediate circuit capacitor(s) may have the lowest possible inductance will have a significant influence on the circuit design.

1-7. (canceled)

8. A power semiconductor module, comprising:
a substrate;
at least two parallel-connected power semiconductor switches situated on the substrate;
at least one intermediate circuit terminal for connecting the power semiconductor switches to a first supply voltage potential; and
at least two intermediate circuit terminals for connecting the power semiconductor switches to a second supply voltage potential, one of the first supply voltage potential and the second supply voltage potential being negative and the other one of the first supply voltage potential and the second supply voltage potential being positive.

9. The power semiconductor module as recited in claim 8, wherein the substrate is a DCB ceramic substrate.

10. The power semiconductor module as recited in claim 8, wherein the power semiconductor switches are one of IGBT, MOSFET or MCT semiconductor chips.

11. The power semiconductor module as recited in claim 8, wherein the power semiconductor module has a phase voltage terminal and is an inverter.

12. The power semiconductor module as recited in claim 8, wherein one of the intermediate circuit terminals having a positive supply voltage potential and one of the intermediate circuit terminals having a negative supply voltage potential are situated in direct proximity to one another on the substrate.

13. A power semiconductor circuit configuration, comprising:
a power semiconductor module including a substrate, at least two parallel-connected power semiconductor switches situated on the substrate, at least one intermediate circuit terminal for connecting the power semiconductor switches to a first supply voltage potential, and at least two intermediate circuit terminals for connecting the power semiconductor switches to a second supply voltage potential, one of the first supply voltage potential and the second supply voltage potential being negative and the other one of the first supply voltage potential and the second supply voltage potential being positive; and
at least one intermediate circuit capacitor electrically connected via feeder lines to the intermediate circuit terminals of the power semiconductor module, a separate feeder line leading from the intermediate circuit capacitor to the power semiconductor module being provided for each intermediate circuit terminal.

14. The power semiconductor circuit configuration as recited in claim 13, wherein one of the intermediate circuit terminals having a positive potential and one of the intermediate circuit terminals having a negative potential are situated in direct proximity on the power semiconductor module, and the feeder lines connected thereto lead to the intermediate circuit capacitor in parallel.
